(19) United States
(12) Patent Application Publication
(10) Pub. No.: US 2021/0012178 A1
(43) Pub. Date: Jan. 14, 2021

(54) SYSTEMS, METHODS, AND DEVICES FOR EARLY-EXIT FROM CONVOLUTION

(71) Applicant: Facebook Technologies, LLC, Menlo Park, CA (US)

(72) Inventors: Ganesh Venkatesh, San Jose, CA (US); Liangzhen Lai, Fremont, CA (US); Pierce I-Jen Chuang, Sunnyvale, CA (US)

(73) Assignee: Facebook Technologies, LLC, Menlo Park, CA (US)

(21) Appl. No.: 16/509,098

(22) Filed: Jul. 11, 2019

(51) Int. Cl. G06N 3/04; G06F 17/16; G06N 3/063; G06N 3/08

(52) U.S. Cl. CPC G06N 3/04; G06N 3/08; G06N 3/063; G06F 17/16

(57) ABSTRACT

Disclosed herein includes a system, a method, and a device for early-exit from convolution. In some embodiments, at least one processing element (PE) circuit is configured to perform, for a node of a neural network corresponding to a dot-product operation with a set of operands, computation using a subset of the set of operands to generate a dot-product value of the subset of the set of operands. The at least one PE circuit can compare the dot-product value of the subset of the set of operands, to a threshold value. The at least one PE circuit can determine whether to activate the node of the neural network, based at least on a result of the comparing.

### FIELD OF DISCLOSURE

The present disclosure is generally related to processing for neural networks, including but not limited to early-exit from convolution in AI accelerators for neural networks.

### BACKGROUND

Machine learning is being implemented in various different computing environments including, for instance, computer vision, image processing, and so forth. Some machine learning systems may incorporate neural networks (e.g., artificial neural networks). However, such implementations of neural networks may be computationally expensive, both from a processing standpoint and from an energy efficiency standpoint.

### SUMMARY

Various embodiments disclosed herein are related to a method for early-exit from convolution. In some embodiments, the method includes performing, by at least one processing element (PE) circuit for a node of a neural network corresponding to a dot-product operation with a set of operands, computation using a subset of the set of operands to generate a dot-product value of the subset of the set of operands. The method can include comparing, by the at least one PE circuit, the dot-product value of the subset of the set of operands, to a threshold value. The method can include determining, by the at least one PE circuit, whether to activate the node of the neural network, based at least on a result of the comparing.

In some embodiments, the method includes identifying, by the at least one PE circuit, the subset of the set of operands to perform the computation. In some embodiments, the method includes selecting a number of operands that causes the partial dot-product value to be at least an amount lower than the threshold value, to be the subset of the set of operands. In some embodiments, the method includes selecting a number of operands that causes the partial dot-product value to be at least an amount higher than the threshold value, to be the subset of the set of operands.

In some embodiments, the method includes re-arranging the set of operands to perform the computation. In some embodiments, the method includes re-arranging the set of operands by re-arranging a neural network graph of the neural network. In some embodiments, the method includes re-arranging operands of at least some nodes or layers of a neural network graph of the neural network. In some embodiments, the method includes setting the threshold value based at least on a desired accuracy of the neural network's output. In some embodiments, the method includes setting the threshold value based at least on a level of power saving achievable by performing the computation using the subset of the set of operands, instead of using all of the set of operands. In some embodiments, the set of operands includes weights or kernels (e.g., kernel elements) of the node.

Various embodiments disclosed herein are related to a device for early-exit from convolution. In some embodiments, the device includes at least one processing element (PE) circuit configured to perform, for a node of a neural network corresponding to a dot-product operation with a set of operands, computation using a subset of the set of operands to generate a dot-product value of the subset of the set of operands. The at least one PE circuit can be configured to compare the dot-product value of the subset of the set of operands, to a threshold value. The at least one PE circuit can be configured to determine whether to activate the node of the neural network, based at least on a result of the comparing.

In some embodiments, the at least one PE circuit is further configured to identify the subset of the set of operands to perform the computation. In some embodiments, the at least one PE circuit is further configured to select a number of operands that causes the partial dot-product value to be at least an amount lower than the threshold value, to be the subset of the set of operands. In some embodiments, the at least one PE circuit is further configured to select a number of operands that causes the partial dot-product value to be at least an amount higher than the threshold value, to be the subset of the set of operands.

In some embodiments, the device further includes a processor configured to re-arrange the set of operands to perform the computation. In some embodiments, the processor is configured to re-arrange the set of operands by re-arranging a neural network graph of the neural network. In some embodiments, the device further includes a processor configured to re-arrange operands of at least some nodes or layers of a neural network graph of the neural network. In some embodiments, the device further includes a processor configured to set the threshold value based at least on a desired accuracy of the neural network's output. In some embodiments, the processor is configured to set the threshold value based at least on a level of power saving achievable by performing the computation using the subset of the set of operands, instead of using all of the set of operands. In some embodiments, the set of operands include weights or kernels of the node.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1A is a block diagram of an embodiment of a system for performing artificial intelligence (AI) related processing, according to an example implementation of the present disclosure.

FIG. 1B is a block diagrams of an embodiment of a device for performing artificial intelligence (AI) related processing, according to an example implementation of the present disclosure.

FIG. 1C is a block diagram of an embodiment of a device for performing artificial intelligence (AI) related processing, according to an example implementation of the present disclosure.

FIG. 1D shows a block diagram of a representative computing system, according to an example implementation of the present disclosure.

FIG. 2A is a block diagram of a device for early-exit from convolution, according to an example implementation of the present disclosure.

FIG. 2B is a flow chart illustrating a process for early-exit from convolution, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

For purposes of reading the description of the various embodiments of the present invention below, the following descriptions of the sections of the specification and their respective contents may be helpful:
Section A describes an environment, system, configuration and/or other aspects useful for practicing or implementing an embodiment of the present systems, methods and devices; and
Section B describes embodiments of devices, systems and methods for early-exit from convolution.

### A. Environment for Artificial Intelligence Related Processing

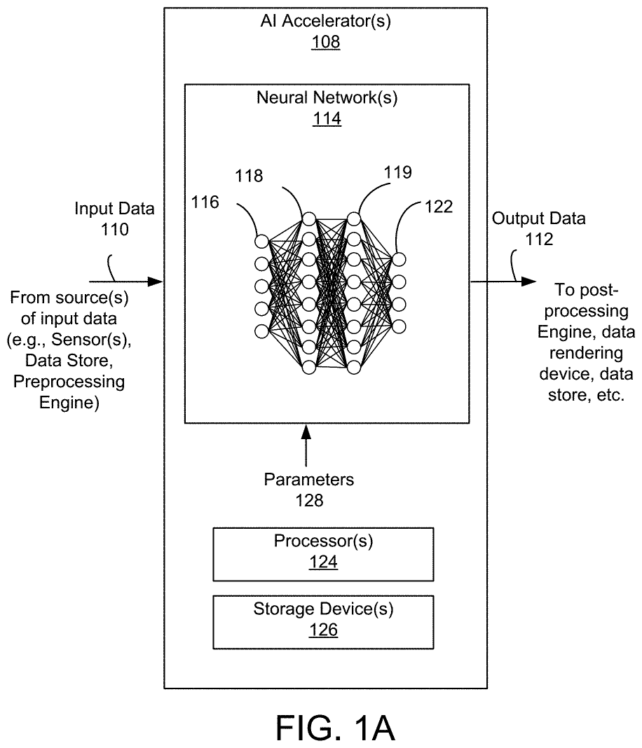

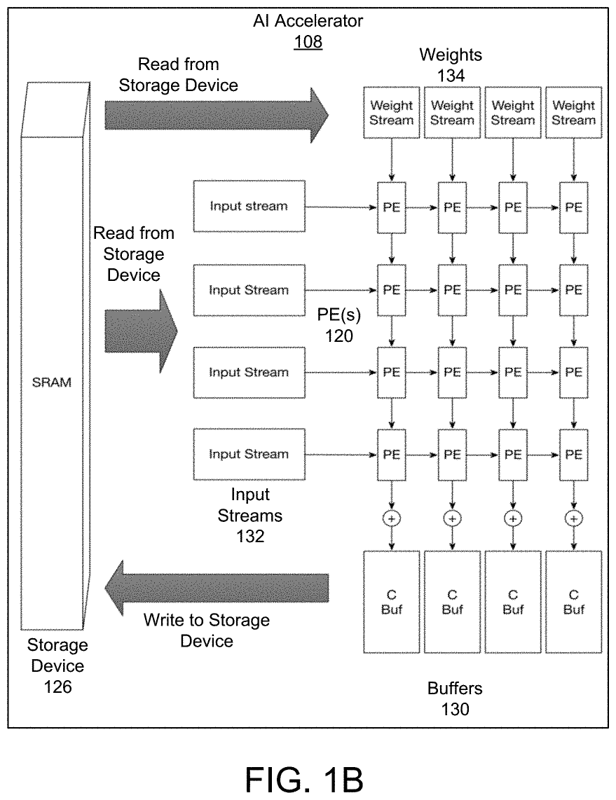

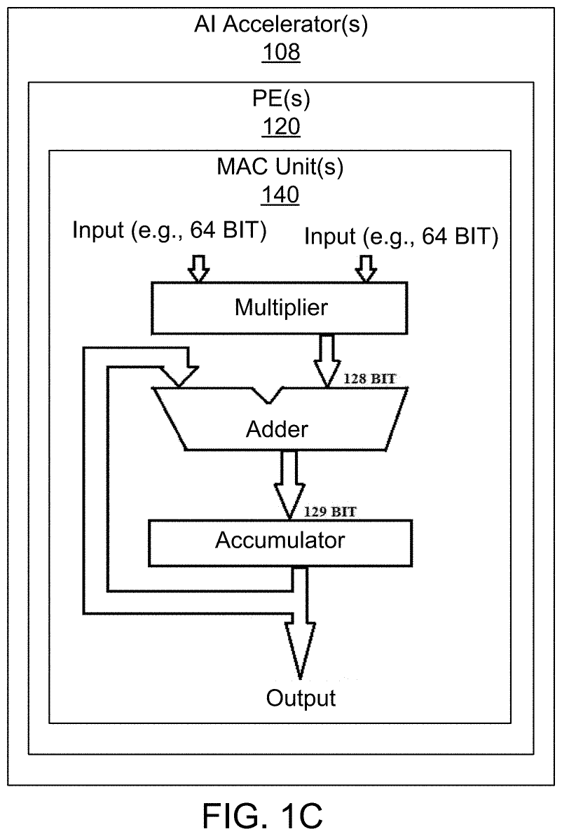

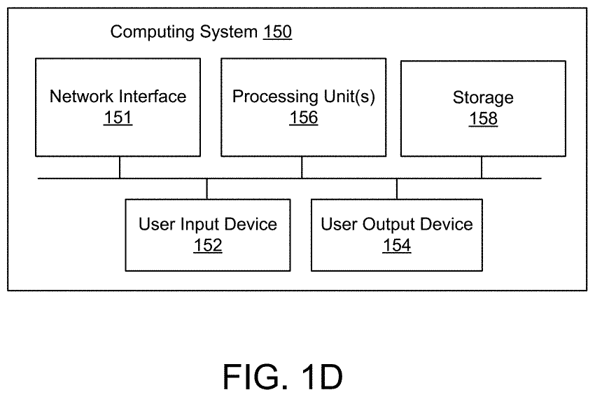

Prior to discussing the specifics of embodiments of systems, devices and/or methods in Section B, it may be helpful to discuss the environments, systems, configurations and/or other aspects useful for practicing or implementing certain embodiments of the systems, devices and/or methods. Referring now to FIG. 1A, an embodiment of a system for performing artificial intelligence (AI) related processing is depicted. In brief overview, the system includes one or more AI accelerators 108 that can perform AI related processing using input data 110. Although referenced as an AI accelerator 108, it is sometimes referred as a neural network accelerator (NNA), neural network chip or hardware, AI processor, AI chip, etc. The AI accelerator(s) 108 can perform AI related processing to output or provide output data 112, according to the input data 110 and/or parameters 128 (e.g., weight and/or bias information). An AI accelerator 108 can include and/or implement one or more neural networks 114 (e.g., artificial neural networks), one or more processor(s) 24 and/or one or more storage devices 126.

Each of the above-mentioned elements or components is implemented in hardware, or a combination of hardware and software. For instance, each of these elements or components can include any application, program, library, script, task, service, process or any type and form of executable instructions executing on hardware such as circuitry that can include digital and/or analog elements (e.g., one or more transistors, logic gates, registers, memory devices, resistive elements, conductive elements, capacitive elements).

The input data 110 can include any type or form of data for configuring, tuning, training and/or activating a neural network 114 of the AI accelerator(s) 108, and/or for processing by the processor(s) 124. The neural network 114 is sometimes referred to as an artificial neural network (ANN). Configuring, tuning and/or training a neural network can refer to or include a process of machine learning in which training data sets (e.g., as the input data 110) such as historical data are provided to the neural network for processing. Tuning or configuring can refer to or include training or processing of the neural network 114 to allow the neural network to improve accuracy. Tuning or configuring the neural network 114 can include, for example, designing, forming, building, synthesizing and/or establishing the neural network using architectures that have proven to be successful for the type of problem or objective desired for the neural network 114. In some cases, the one or more neural networks 114 may initiate at a same or similar baseline model, but during the tuning, training or learning process, the results of the neural networks 114 can be sufficiently different such that each neural network 114 can be tuned to process a specific type of input and generate a specific type of output with a higher level of accuracy and reliability as compared to a different neural network that is either at the baseline model or tuned or trained for a different objective or purpose. Tuning the neural network 114 can include setting different parameters 128 for each neural network 114, fine-tuning the parameters 114 differently for each neural network 114, or assigning different weights (e.g., hyperparameters, or learning rates), tensor flows, etc. Thus, setting appropriate parameters 128 for the neural network(s) 114 based on a tuning or training process and the objective of the neural network(s) and/or the system, can improve performance of the overall system.

A neural network 114 of the AI accelerator 108 can include any type of neural network including, for example, a convolution neural network (CNN), deep convolution network, a feed forward neural network (e.g., multilayer perceptron (MLP)), a deep feed forward neural network, a radial basis function neural network, a Kohonen self-organizing neural network, a recurrent neural network, a modular neural network, a long/short term memory neural network, etc. The neural network(s) 114 can be deployed or used to perform data (e.g., image, audio, video) processing, object or feature recognition, recommender functions, data or image classification, data (e.g., image) analysis, etc., such as natural language processing.

As an example, and in one or more embodiments, the neural network 114 can be configured as or include a convolution neural network. The convolution neural network can include one or more convolution cells (or pooling layers) and kernels, that can each serve a different purpose. The convolution neural network can include, incorporate and/or use a convolution kernel (sometimes simply referred as “kernel”). The convolution kernel can process input data, and the pooling layers can simplify the data, using, for example, non-linear functions such as a max, thereby reducing unnecessary features. The neural network 114 including the convolution neural network can facilitate image, audio or any data recognition or other processing. For example, the input data 110 (e.g., from a sensor) can be passed to convolution layers of the convolution neural network that form a funnel, compressing detected features in the input data 110. The first layer of the convolution neural network can detect first characteristics, the second layer can detect second characteristics, and so on.

The convolution neural network can be a type of deep, feed-forward artificial neural network configured to analyze visual imagery, audio information, and/or any other type or form of input data 110. The convolution neural network can include multilayer perceptrons designed to use minimal preprocessing. The convolution neural network can include or be referred to as shift invariant or space invariant artificial neural networks, based on their shared-weights architecture and translation invariance characteristics. Since convolution neural networks can use relatively less pre-processing compared to other data classification/processing algorithms, the convolution neural network can automatically learn the filters that may be hand-engineered for other data classification/processing algorithms, thereby improving the efficiency associated with configuring, establishing or setting up the neural network 114, thereby providing a technical advantage relative to other data classification/processing techniques.

The neural network 114 can include an input layer 116 and an output layer 122, of neurons or nodes. The neural network 114 can also have one or more hidden layers 118, 119 that can include convolution layers, pooling layers, fully connected layers, and/or normalization layers, of neurons or nodes. In a neural network 114, each neuron can receive input from some number of locations in the previous layer. In a fully connected layer, each neuron can receive input from every element of the previous layer.

Each neuron in a neural network 114 can compute an output value by applying some function to the input values coming from the receptive field in the previous layer. The function that is applied to the input values is specified by a vector of weights and a bias (typically real numbers). Learning (e.g., during a training phase) in a neural network 114 can progress by making incremental adjustments to the biases and/or weights. The vector of weights and the bias can be called a filter and can represent some feature of the input (e.g., a particular shape). A distinguishing feature of convolutional neural networks is that many neurons can share the same filter. This reduces memory footprint because a single bias and a single vector of weights can be used across all receptive fields sharing that filter, rather than each receptive field having its own bias and vector of weights.

For example, in a convolution layer, the system can apply a convolution operation to the input layer 116, passing the result to the next layer. The convolution emulates the response of an individual neuron to input stimuli. Each convolutional neuron can process data only for its receptive field. Using the convolution operation can reduce the number of neurons used in the neural network 114 as compared to a fully connected feedforward neural network. Thus, the convolution operation can reduce the number of free parameters, allowing the network to be deeper with fewer parameters. For example, regardless of an input data (e.g., image data) size, tiling regions of size 5×5, each with the same shared weights, may use only 25 learnable parameters. In this way, the first neural network 114 with a convolution neural network can resolve the vanishing or exploding gradients problem in training traditional multi-layer neural networks with many layers by using backpropagation.

The neural network 114 (e.g., configured with a convolution neural network) can include one or more pooling layers. The one or more pooling layers can include local pooling layers or global pooling layers. The pooling layers can combine the outputs of neuron clusters at one layer into a single neuron in the next layer. For example, max pooling can use the maximum value from each of a cluster of neurons at the prior layer. Another example is average pooling, which can use the average value from each of a cluster of neurons at the prior layer.

The neural network 114 (e.g., configured with a convolution neural network) can include fully connected layers. Fully connected layers can connect every neuron in one layer to every neuron in another layer. The neural network 114 can be configured with shared weights in convolutional layers, which can refer to the same filter being used for each receptive field in the layer, thereby reducing a memory footprint and improving performance of the first neural network 114.

The hidden layers 118, 119 can include filters that are tuned or configured to detect information based on the input data (e.g., sensor data, from a virtual reality system for instance). As the system steps through each layer in the neural network 114 (e.g., convolution neural network), the system can translate the input from a first layer and output the transformed input to a second layer, and so on. The neural network 114 can include one or more hidden layers 118, 119 based on the type of object or information being detected, processed and/or computed, and the type of input data 110.

In some embodiments, the convolutional layer is the core building block of a neural network 114 (e.g., configured as a CNN). The layer's parameters 128 can include a set of learnable filters (or kernels), which have a small receptive field, but extend through the full depth of the input volume. During the forward pass, each filter is convolved across the width and height of the input volume, computing the dot product between the entries of the filter and the input and producing a 2-dimensional activation map of that filter. As a result, the neural network 114 can learn filters that activate when it detects some specific type of feature at some spatial position in the input. Stacking the activation maps for all filters along the depth dimension forms the full output volume of the convolution layer. Every entry in the output volume can thus also be interpreted as an output of a neuron that looks at a small region in the input and shares parameters with neurons in the same activation map. In a convolutional layer, neurons can receive input from a restricted subarea of the previous layer. Typically, the subarea is of a square shape (e.g., size 5 by 5). The input area of a neuron is called its receptive field. So, in a fully connected layer, the receptive field is the entire previous layer. In a convolutional layer, the receptive area can be smaller than the entire previous layer.

The first neural network 114 can be trained to detect, classify, segment and/or translate input data 110 (e.g., by detecting or determining the probabilities of objects, events, words and/or other features, based on the input data 110). For example, the first input layer 116 of neural network 114 can receive the input data 110, process the input data 110 to transform the data to a first intermediate output, and forward the first intermediate output to a first hidden layer 118. The first hidden layer 118 can receive the first intermediate output, process the first intermediate output to transform the first intermediate output to a second intermediate output, and forward the second intermediate output to a second hidden layer 119. The second hidden layer 119 can receive the second intermediate output, process the second intermediate output to transform the second intermediate output to a third intermediate output, and forward the third intermediate output to an output layer 122 for example. The output layer 122 can receive the third intermediate output, process the third intermediate output to transform the third intermediate output to output data 112, and forward the output data 112 (e.g., possibly to a post-processing engine, for rendering to a user, for storage, and so on). The output data 112 can include object detection data, enhanced/translated/augmented data, a recommendation, a classification, and/or segmented data, as examples.

Referring again to FIG. 1A, the AI accelerator 108 can include one or more storage devices 126. A storage device 126 can be designed or implemented to store, hold or maintain any type or form of data associated with the AI accelerator(s) 108. For example, the data can include the input data 110 that is received by the AI accelerator(s) 108, and/or the output data 112 (e.g., before being output to a next device or processing stage). The data can include intermediate data used for, or from any of the processing stages of a neural network(s) 114 and/or the processor(s) 124. The data can include one or more operands for input to and processing at a neuron of the neural network(s) 114, which can be read or accessed from the storage device 126. For example, the data can include input data, weight information and/or bias information, activation function information, and/or parameters 128 for one or more neurons (or nodes) and/or layers of the neural network(s) 114, which can be stored in and read or accessed from the storage device 126. The data can include output data from a neuron of the neural network(s) 114, which can be written to and stored at the storage device 126. For example, the data can include activation data, refined or updated data (e.g., weight information and/or bias information from a training phase for example, activation function information, and/or other parameters 128) for one or more neurons (or nodes) and/or layers of the neural network(s) 114, which can be transferred or written to, and stored in the storage device 126.

In some embodiments, the AI accelerator 108 can include one or more processors 124. The one or more processors 124 can include any logic, circuitry and/or processing component (e.g., a microprocessor) for pre-processing input data for any one or more of the neural network(s) 114 or AI accelerator(s) 108, and/or for post-processing output data for any one or more of the neural network(s) 114 or AI accelerator(s) 108. The one or more processors 124 can provide logic, circuitry, processing component and/or functionality for configuring, controlling and/or managing one or more operations of the neural network(s) 114 or AI accelerator(s) 108. For instance, a processor 124 may receive data or signals associated with a neural network 114 to control or reduce power consumption (e.g., via clock-gating controls on circuitry implementing operations of the neural network 114). As another example, a processor 124 may partition and/or re-arrange data for separate processing (e.g., at various components of an AI accelerator 108, in parallel for example), sequential processing (e.g., on the same component of an AI accelerator 108, at different times or stages), or for storage in different memory slices of a storage device, or in different storage devices. In some embodiments, the processor(s) 124 can configure a neural network 114 to operate for a particular context, provide a certain type of processing, and/or to address a specific type of input data, e.g., by identifying, selecting and/or loading specific weight, activation function and/or parameter information to neurons and/or layers of the neural network 114.

In some embodiments, the AI accelerator 108 is designed and/or implemented to handle or process deep learning and/or AI workloads. For example, the AI accelerator 108 can provide hardware acceleration for artificial intelligence applications, including artificial neural networks, machine vision and machine learning. The AI accelerator 108 can be configured for operation to handle robotics related, internet of things (IoT) related, and other data-intensive or sensor-driven tasks. The AI accelerator 108 may include a multi-core or multiple processing element (PE) design, and can be incorporated into various types and forms of devices such as artificial reality (e.g., virtual, augmented or mixed reality) systems, smartphones, tablets, and computers. Certain embodiments of the AI accelerator 108 can include or be implemented using at least one digital signal processor (DSP), co-processor, microprocessor, computer system, heterogeneous computing configuration of processors, graphics processing unit (GPU), field-programmable gate array (FPGA), and/or application-specific integrated circuit (ASIC). The AI accelerator 108 can be a transistor based, semiconductor based and/or a quantum computing based device.

Referring now to FIG. 1B, an example embodiment of a device for performing AI related processing is depicted. In brief overview, the device can include or correspond to an AI accelerator 108, e.g., with one or more features described above in connection with FIG. 1A. The AI accelerator 108 can include one or more storage devices 126 (e.g., memory such as a static random-access memory (SRAM) device), one or more buffers, a plurality or array of processing element (PE) circuits, other logic or circuitry (e.g., adder circuitry), and/or other structures or constructs (e.g., interconnects, data buses, clock circuitry, power network(s)). Each of the above-mentioned elements or components is implemented in hardware, or at least a combination of hardware and software. The hardware can for instance include circuit elements (e.g., one or more transistors, logic gates, registers, memory devices, resistive elements, conductive elements, capacitive elements, and/or wire or electrically conductive connectors).

In a neural network 114 (e.g., artificial neural network) implemented in the AI accelerator 108, neurons can take various forms and can be referred to as processing elements (PEs) or PE circuits. The neuron can be implemented as a corresponding PE circuit, and the processing/activation that can occur at the neuron can be performed at the PE circuit. The PEs are connected into a particular network pattern or array, with different patterns serving different functional purposes. The PE in an artificial neural network operate electrically (e.g., in the embodiment of a semiconductor implementation), and may be either analog, digital, or a hybrid. To parallel the effect of a biological synapse, the connections between PEs can be assigned multiplicative weights, which can be calibrated or “trained” to produce the proper system output.

A PE can be defined in terms of the following equations (e.g., which represent a McCulloch-Pitts model of a neuron):

′=Σᵢwᵢxᵢ (1)

y=σ(ζ) (2)

Where ζ is the weighted sum of the inputs (e.g., the inner product of the input vector and the tap-weight vector), and σ(ζ) is a function of the weighted sum. Where the weight and input elements form vectors w and x, the ζ weighted sum becomes a simple dot product:

ζ=w·x (3)

This may be referred to as either the activation function (e.g., in the case of a threshold comparison) or a transfer function. In some embodiments, one or more PEs can be referred to as a dot product engine. The input (e.g., input data 110) to the neural network 114, x, can come from an input space and the output (e.g., output data 112) are part of the output space. For some neural networks, the output space Y may be as simple as {0, 1}, or it may be a complex multi-dimensional (e.g., multiple channel) space (e.g., for a convolutional neural network). Neural networks tend to have one input per degree of freedom in the input space, and one output per degree of freedom in the output space.

In some embodiments, the PEs can be arranged and/or implemented as a systolic array. A systolic array can be a network (e.g., a homogeneous network) of coupled data processing units (DPUs) such as PEs, called cells or nodes. Each node or PE can independently compute a partial result as a function of the data received from its upstream neighbors, can store the result within itself and can pass the result downstream for instance. The systolic array can be hardwired or software configured for a specific application. The nodes or PEs can be fixed and identical, and interconnect of the systolic array can be programmable. Systolic arrays can rely on synchronous data transfers.

Referring again to FIG. 1B, the input x to a PE 120 can be part of an input stream 132 that is read or accessed from a storage device 126 (e.g., SRAM). An input stream 132 can be directed to one row (horizontal bank or group) of PEs, and can be shared across one or more of the PEs, or partitioned into data portions (overlapping or non-overlapping data portions) as inputs for respective PEs. Weights 134 (or weight information) in a weight stream (e.g., read from the storage device 126) can be directed or provided to a column (vertical bank or group) of PEs. Each of the PEs in the column may share the same weight 134 or receive a corresponding weight 134. The input and/or weight for each target PE can be directly routed (e.g., from the storage device 126) to the target PE (e.g., without passing through other PE(s)), or can be routed through one or more PEs (e.g., along a row or column of PEs) to the target PE. The output of each PE can be routed directly out of the PE array (e.g., without passing through other PE(s)), or can be routed through one or more PEs (e.g., along a column of PEs) to exit the PE array. The outputs of each column of PEs can be summed or added at an adder circuitry of the respective column, and provided to a buffer 130 for the respective column of PEs. The buffer(s) 130 can provide, transfer, route, write and/or store the received outputs to the storage device 126. In some embodiments, the outputs (e.g., activation data from one layer of the neural network) that are stored by the storage device 126 can be retrieved or read from the storage device 126, and be used as inputs to the array of PEs 120 for processing (of a subsequent layer of the neural network) at a later time. In certain embodiments, the outputs that are stored by the storage device 126 can be retrieved or read from the storage device 126 as output data 112 for the AI accelerator 108.

Referring now to FIG. 1C, one example embodiment of a device for performing AI related processing is depicted. In brief overview, the device can include or correspond to an AI accelerator 108, e.g., with one or more features described above in connection with FIGS. 1A and 1B. The AI accelerator 108 can include one or more PEs 120, other logic or circuitry (e.g., adder circuitry), and/or other structures or constructs (e.g., interconnects, data buses, clock circuitry, power network(s)). Each of the above-mentioned elements or components is implemented in hardware, or at least a combination of hardware and software. The hardware can for instance include circuit elements (e.g., one or more transistors, logic gates, registers, memory devices, resistive elements, conductive elements, capacitive elements, and/or wire or electrically conductive connectors).

In some embodiments, a PE 120 can include one or more multiply-accumulate (MAC) units or circuits 140. One or more PEs can sometimes be referred to (singly or collectively) as a MAC engine. A MAC unit is configured to perform multiply—accumulate operation(s). The MAC unit can include a multiplier circuit, an adder circuit and/or an accumulator circuit. The multiply—accumulate operation computes the product of two numbers and adds that product to an accumulator. The MAC operation can be represented as follows, in connection with an accumulator operand a, and inputs b and c:

a←a+(b×c) (4)

In some embodiments, a MAC unit 140 may include a multiplier implemented in combinational logic followed by an adder (e.g., that includes combinational logic) and an accumulator register (e.g., that includes sequential and/or combinational logic) that stores the result. The output of the accumulator register can be fed back to one input of the adder, so that on each clock cycle, the output of the multiplier can be added to the accumulator register.

As discussed above, a MAC unit 140 can perform both multiply and addition functions. The MAC unit 140 can operate in two stages. The MAC unit 140 can first compute the product of given numbers (inputs) in a first stage, and forward the result for the second stage operation (e.g., addition and/or accumulate). An n-bit MAC unit 140 can include an n-bit multiplier, 2n-bit adder, and 2n-bit accumulator. An array or plurality of MAC units 140 (e.g., in PEs) can be arranged in a systolic array, for parallel integration, convolution, correlation, matrix multiplication, data sorting, and/or data analysis tasks.

Various systems and/or devices described herein can be implemented in a computing system. FIG. 1D shows a block diagram of a representative computing system 150. In some embodiments, the system of FIG. 1A can form at least part of the processing unit(s) 156 (or processors 156) of the computing system 150. Computing system 150 can be implemented, for example, as a device (e.g., consumer device) such as a smartphone, other mobile phone, tablet computer, wearable computing device (e.g., smart watch, eyeglasses, head mounted display), desktop computer, laptop computer, or implemented with distributed computing devices. The computing system 150 can be implemented to provide VR, AR, MR experience. In some embodiments, the computing system 150 can include conventional, specialized or custom computer components such as processors 156, storage device 158, network interface 151, user input device 152, and user output device 154.

Network interface 151 can provide a connection to a local/wide area network (e.g., the Internet) to which network interface of a (local/remote) server or back-end system is also connected. Network interface 151 can include a wired interface (e.g., Ethernet) and/or a wireless interface implementing various RF data communication standards such as Wi-Fi, Bluetooth, or cellular data network standards (e.g., 3G, 4G, 5G, LTE, etc.).

User input device 152 can include any device (or devices) via which a user can provide signals to computing system 150; computing system 150 can interpret the signals as indicative of particular user requests or information. User input device 152 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 154 can include any device via which computing system 150 can provide information to a user. For example, user output device 154 can include a display to display images generated by or delivered to computing system 150. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. User output devices 154 can be provided in addition to or instead of a display. Examples include indicator lights, speakers, tactile “display” devices, printers, and so on.

Some implementations include electronic components, such as microprocessors, storage and memory that store computer program instructions in a non-transitory computer readable storage medium. Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 156 can provide various functionality for computing system 150, including any of the functionality described herein as being performed by a server or client, or other functionality associated with message management services.

It will be appreciated that computing system 150 is illustrative and that variations and modifications are possible. Computer systems used in connection with the present disclosure can have other capabilities not specifically described here. Further, while computing system 150 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

B. Methods and Devices for Early-Exit from Convolution

Disclosed herein include embodiments of a system, a method, and a device for early-exit from convolution. Specifically, at least some aspects of this disclosure are directed to an early-exit strategy for wide dot-product operation at a node in a layer of a neural network. In general, at a node, activation to a 1 or 0 (among other values, ranges, etc.) can be based on a dot-product operation performed for the node (e.g., by a MAC unit or engine). For instance, if the dot-product operation yields a positive or larger computed value (e.g., relative to a threshold value), the node may provide or output an activation to 1, and if the dot-product operation yields a negative or lower computed value (e.g., relative to a threshold value), the node may provide or output an activation to 0. For a dot-product operation with many elements (e.g., a vector or matrix including a large quantity of values or elements), computing the dot-product operation may be computationally expensive, time consuming and/or power inefficient.

According to the implementations described herein, rather than performing a dot-product operation with all of the elements of the vector or matrix, the embodiments described herein provide for a node computing a partial dot-product for a subset of elements (e.g., a subset of the values of the vector or matrix). The computed partial dot-product for the subset of elements may be compared to a threshold (e.g., threshold value or reference value). The threshold may be set to determine whether or not to perform a full dot-product operation on each of the elements of the vector. The threshold may be selected to balance output accuracy with reductions in power consumption. Based on the comparison of the computed dot-product for the subset to the threshold, the node may forego computation of the full dot-product operation, thus allowing an early-exit from the processing (e.g., convolution or dot production operation) at the node. Such reduced processing can result in reduced power consumption.

In some embodiments, processor(s) 140 may select the subset of elements for computing the partial dot-product. The processor(s) 140 may select the subset of elements by comparing and rearranging the values of the elements (e.g., weights or kernels), so that either the most negative-causing values or most positive-causing values (as a subset of all elements) can be computed first to increase the chances that the partial sum product is significantly above or significantly below the selected threshold, hence allowing for an earlier exit, and enhanced power savings. The rearrangement of the values for partial dot product can be implemented via a rearrangement of a neural network graph (e.g., to be mapped to or implemented on an array of PEs 120) for instance. The threshold can be adjusted, determined or selected based on a compromise or balance between accuracy of the neural network output/result and the level of power savings, for instance.

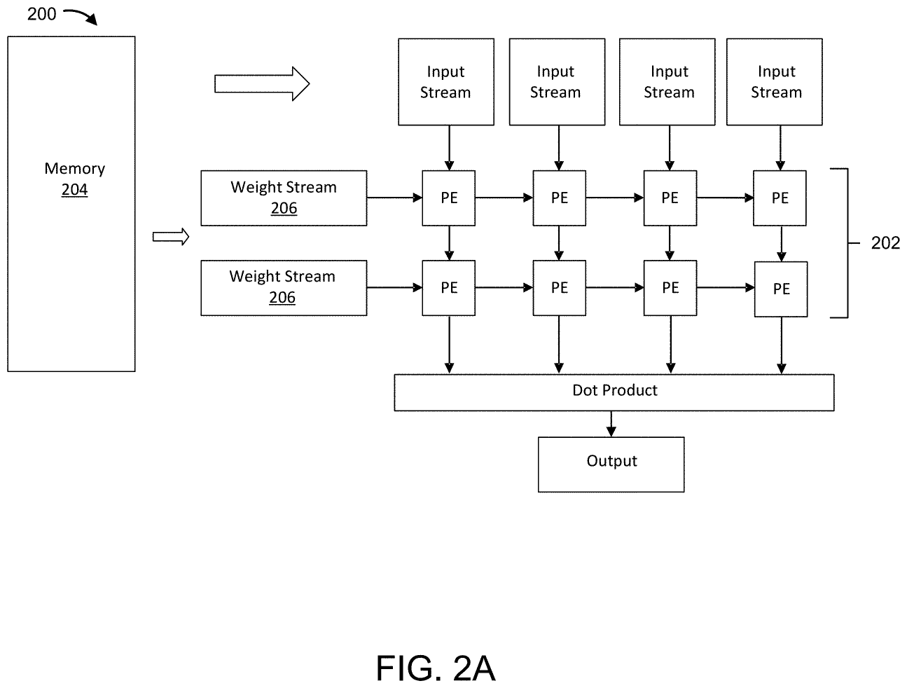

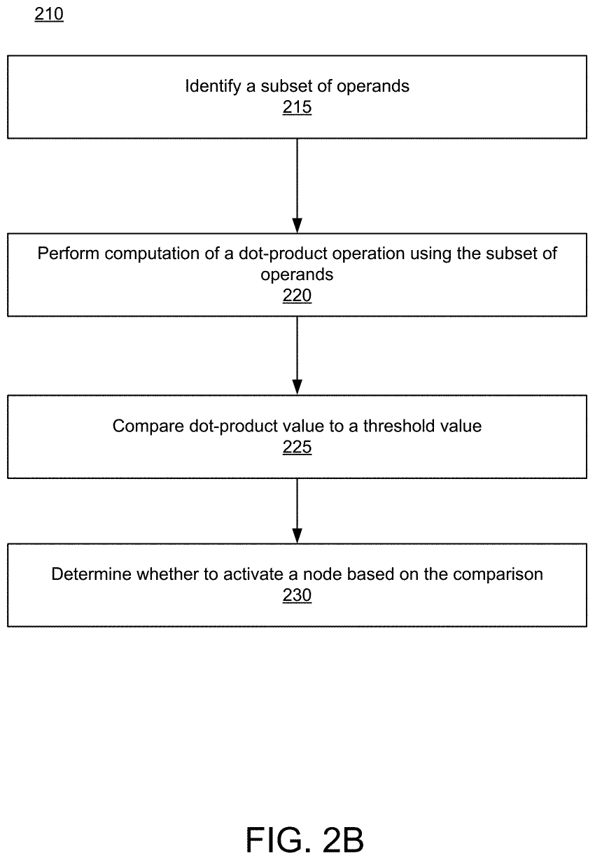

Referring now to FIG. 2A, depicted is a block diagram of a device 200 for early-exit from convolution. At least some of the components depicted in FIG. 2A may be similar to those depicted in FIG. 1B and described above. For instance, the device 200 may be or include an AI Accelerator 108. The device 200 may include a plurality or array of processing element (PE) circuits 202, which may be similar in some aspects to the PE circuit(s) 120 described above in Section A. Similarly, the device 200 may include a storage device 204, and weights 206, which may be similar in some respects to the storage device 126, and weights 134, respectively, described above. As described in greater detail below, the processor(s) 124 and/or PE circuit(s) 202 may be configured to identify a subset of operands (e.g., subset of elements of a vector or matrix operand) for which to compute a dot-product value using a dot-product operation. The PE circuit(s) 202 may be configured to compute the dot-product value using the subset of operands. The PE circuit(s) 202 may compare the dot-product value with a threshold value. The PE circuit(s) 202 may determine whether to compute a dot-product value using the full set of operands) based on the comparison.

Each of the above-mentioned elements or components is implemented in hardware, or a combination of hardware and software. For instance, each of these elements or components can include any application, program, library, script, task, service, process or any type and form of executable instructions executing on hardware such as circuitry that can include digital and/or analog elements (e.g., one or more transistors, logic gates, registers, memory devices, resistive elements, conductive elements, capacitive elements).

The device 200 is shown to include a storage device 204 (e.g., memory). The storage device 204 may be or include any device, component, element, or subsystem of the device 200 designed or implemented to store data. The storage device 204 may store data by having data written to the storage device 204. The data may subsequently be retrieved from the storage device 204 (e.g., by other elements or components of the device 200). In some implementations, the storage device 204 may include a Static Random Access Memory (SRAM). The storage device 204 may be designed or implemented to store data for a neural network (e.g., data or information for various layers of the neural network, data or information for various nodes within respective layers of the neural network, etc.). For example, the data can include activation data or information, refined or updated data (e.g., weight information and/or bias information from a training phase for example, activation function information, and/or other parameters) for one or more neurons (or nodes) and/or layers of the neural network, which can be transferred or written to, and stored in the storage device 204. As described in greater detail below, the PE circuits 202 may be configured to use the data from the storage device 204 to generate intermediate data or outputs for the neural network.

The device 200 is shown to include a plurality of PE circuits 202. Each PE circuit 202 may be similar in some respects to the PE circuits 120 described above. The PE circuits 202 may be designed or implemented to read input data from a data source and perform one or more computations (e.g., using the weight streams) to generate corresponding data. The input data may include an input stream (e.g., from the storage device 204), an activation stream (e.g., generated from a previous layer or node of the neural network), and so forth. In some embodiments, at least some of the PE circuit(s) 202 may correspond to various layers (or nodes within layers) of the neural network. For instance, some PE circuit(s) 202 may correspond to an input layer, other PE circuit(s) 202 may correspond to an output layer, and still other PE circuit(s) 202 may correspond to hidden layers. At least one PE circuit 202 may correspond to a node of the neural network corresponding to a dot-product operation. In some embodiments, a plurality of PE circuits 202 may correspond to the node of the neural network corresponding to the dot-product operation. Such PE circuit(s) 202 may be responsible for performing computations related to dot-product operations. In some embodiments, the PE circuit(s) 202 may be configured to perform computations related to a dot-product operation with a set of operands. The operands may be or include activation data, input data, weights, kernels, and so forth, or elements thereof.

In some implementations, the dot-product operation may be or include a mathematical operation by which values from two vectors (e.g., a first vector and a second vector) are multiplied by each other and summed. The first vector may be an input vector and the second vector may be a kernel, for example. The kernel may be stored in the storage device 204, whereas the input vector may be or include values generated by the PE circuits 202 (e.g., during computations from one or more layers of the neural network). For instance, such a dot-product operation may follow the example shown in equation 1 below:

[ABCD]·[EFGH]=A×E+B×F+C×G+D×H Eq. 1

In some implementations, the dot-product operation may be or include a mathematical operation by which values from a vector are multiplied by a scalar (e.g., a weight from the storage device 204) and summed. For instance, such a dot-product operation may follow the example shown in equation 2 below:

[A]·[EFGH]=A×E+A×F+A×G+A×H Eq. 2

In each of the embodiments of equation 1 and equation 2, the dot-product operation may compute a value representing the sum of elements of a vector multiplied by another element. Depending on the length of the vector(s) being multiplied, the dot-product operation may be computationally expensive.

The PE circuit(s) 202 may be configured to identify a subset of operands to perform computation of a dot-product operation. As shown in FIG. 1A, and in some implementations, the AI accelerator 108 may include one or more processors 124. The processor(s) 124 may be configured to select, from the set of operands, a subset of operands to perform computation of a dot-product operation. The processor(s) 124 may be configured to select the subset of operands based on relative values of the operands. As stated above, the operands may include the kernel or weight values against which an input value is multiplied, or the input values. The processor(s) 124 may be configured to select the subset of operands based on which operands are most positive or largest in value (e.g., relative to a reference value, for instance 0). For instance, where the output from the node activates to a high (or one, “1”), the processor(s) 124 may be configured to select operands having the most positive (or least negative) values. As another example, where the output from the node activates to a low (or zero, “0”), the processor(s) 124 may be configured to select operands having the least positive (or most negative) values. The processor(s) 124 may be configured to identify the most positive or most negative values using the input value or the kernel or weight value. For instance, where the input values are similar (or substantially the same) but the values within the kernel vary, the processor(s) 124 may be configured to select the operands based on the values from the kernel (e.g., values within the kernel having highest weights, lowest weights, most positive weights, most negative weights, etc.).

In some implementations, the processor(s) 124 may be configured to re-arrange the set of operands to select the subset of operands to perform computation. As described in greater detail above, a neural network graph may be a representation of a neural network. The neural network graph may include or correspond to (or be represented by) a set of pointers (or addresses) of memory locations having operands to be processed for a given node. The address(es) or pointer(s) may correspond to location(s) within the storage device 204. The processor(s) 124 may be configured to re-arrange the operands from the set of the operands (e.g., within the vectors), or select a subset from the set of operands, by modifying or selecting one or more pointers (or addresses) corresponding to the operands, associated with the neural network graph. The processor(s) 124 may re-arrange and/or select operands, and may correspondingly re-arrange and/or select nodes (or PEs) mapped or configured to the neural network graph, to process or operate on a subset of the set of operands. By modifying the pointers (or addresses), the processor(s) 124 may be configured to re-arrange the set of operands and/or the neural network graph. Hence, the processor(s) 124 may for example modify the neural network graph by modifying, re-arranging or updating addresses and/or pointers to memory locations where operands are stored for particular nodes of the neural network. In some implementations, the processor(s) 124 may be configured to re-arrange the operands (in an array, matrix, sequence, order or other arrangement or configuration that is mapped to the neural network graph for instance), to identify operands for which to perform computations corresponding to the dot-product operation. The processor(s) 124 may re-arrange the operands in ascending or descending order of size, value or magnitude (including absolute magnitude) for instance. The processor(s) 124 may be configured to re-arrange the operands while maintaining pairs of operands (e.g., input or activation data, and corresponding weight and/or kernel values).

In some implementations, the most negative-causing values and/or the most positive-causing values can be computed first. For instance, the processor(s) 124 may re-arrange the operands in accordance with the absolute magnitude of each of the operands. As such, the operands may be re-arranged in, for instance, descending order, with the largest absolute magnitude (e.g., most positive and/or most negative) values being arranged first, and values closest to zero being arranged last. As described in greater detail below, the processor(s) 124 may be configured to select a subset of operands for which to compute a partial dot-product value. The processor(s) 124 may select the subset of operands having the most positive and most negative (e.g., those having the greatest absolute magnitude), so that the most negative-causing values and/or the most positive-causing values can be computed first. In some embodiments, the processor(s) may select operands whose absolute magnitude is larger than a predetermined (absolute magnitude) threshold.

The processor(s) 124 may be configured to select a number of operands from the full set of operands for including in the subset of operands. As described in greater detail below, the PE circuit(s) 202 may be configured to perform a dot-product operation on the subset of operands to generate a first (partial) dot-product value. The PE circuit(s) 202 may be configured to perform a comparison of the first dot-product value to a first threshold (e.g., a threshold for a partial dot-product value or operation). The first threshold may be a value which, when met, satisfied or exceeded by the dot-product value, indicates a high degree of likelihood of a particular outcome from a dot-product operation of the full set of operands. The particular outcome may comprise satisfaction of a threshold defined for a full/complete dot-product operation on the full set of operands, for example. The number of operands for the subset may change based on a desired balance between computing efficiency and accuracy. For instance, while accuracy of the likelihood of the particular outcome may increase where the PE circuit(s) 202 compute the dot-product operation for a larger number of operands (e.g., a larger subset of operands), the computing efficiency may correspondingly decrease. On the other hand, while the computing efficiency increases where the PE circuit(s) 202 compute the dot-product operation for a lesser number of operands (e.g., a smaller subset of operands), the accuracy of the likelihood of the particular outcome can correspondingly decrease. According to the environment in which the systems and methods described herein are implemented, the number of operands selected may change based on the balance between accuracy and computing efficiency (e.g., a selection of a greater number of operands where accuracy is more important and vice versa).

The processor(s) 124 may be configured to select, from the full set of operands, a subset of operands for which the PE circuit(s) 202 are to perform computations corresponding to the dot-product operation. For instance, using the example included in equation 1, the processor(s) 124 may be configured to select, from the full set of operands—[A B C D] [E F G H]—a subset of the operands—[A D] [E H]—for which the PE circuit(s) 202 are to perform computations corresponding to the dot product. As such, the processor(s) 124 may be configured to maintain pairs of operands (A E) and (D H) following re-arrangement or other steps made in the selection of the subset of operands. The processor(s) 124 may be configured to select the subset of operands by sorting the operands (e.g., in ascending or descending order), by re-arranging the operands, by re-arranging the neural network graph, etc. The processor(s) 124 may select a subset of operands having the highest/lowest values. The processor(s) 124 may be configured to assign and/or provide the subset of operands to the PE circuit(s) 202 for performing a partial dot-product operation.

The PE circuit(s) 202 may be configured to perform a partial dot-product operation on the subset of operands. The PE circuit(s) 202 may be configured to perform the partial dot-product operation in accordance with equation 1 (or equation 2). Continuing the example above, the PE circuit(s) 202 may be configured to perform computations corresponding to a partial dot-product operation for the subset of operands—[A D] [E H]—to generate a partial dot-product value (e.g., A×E+D×H) for which to compare to a threshold. As such, rather than computing a full dot-product operation on each of the operands, during a first iteration, the PE circuit(s) 202 may be configured to perform a partial dot-product operation on a subset of the operands, with the subset of operands being those which are most likely to satisfy a threshold (e.g., the operands having particular type(s) of value(s) where the first threshold is satisfied such that the corresponding full/complete dot-product value is expected to exceed a corresponding threshold, and/or the operands having certain type(s) of value(s) where the first threshold is satisfied such that the corresponding full/complete dot-product value is expected to be lower than the corresponding threshold, etc.).

In some implementations, a criteria for early-exit can be a measurement or value of the slope of computed values (e.g., partial dot-products). The processor(s) 124 may be configured to compute a slope computed values, for example following or prior to re-arrangement of the operands based on absolute magnitude. The processor(s) 124 may compute the slope of computed values corresponding to different subsets of operands, or an increasing subset of operands. The processor(s) 124 may be configured to determine if a value of the slope is trending upwards or downwards, for determining whether or not to compute a full dot-product value or perform early-exit. By way of illustration, in the case of negative values (e.g., for setting activation to 0), if the computed value is already negative and continues to go more negative (or go more positive), then such a slope or trend of computed values (and/or the absolute magnitude threshold) can be used as a criteria for early-exit.

The PE circuit(s) 202 may be configured to apply, transmit, send, buffer, or otherwise provide the dot-product value for the subset of operands to a comparator. The comparator may be configured to compare the dot-product value to the first threshold. The threshold may a fixed or predetermined number or value to which the dot-product value (for the subset of operands) is compared. The first threshold may be set according to a likelihood of a dot-product value computed for the complete set of operands (e.g., instead of just the subset) satisfying a threshold predetermined for the complete set of operands. For instance, the first threshold may be set sufficiently high (or low) such that it is unlikely that the complete set of operands would produce a threshold-related result, decision or outcome different from that of the subset.

Similar to the number of operands selected, the first threshold may be set based on a desired accuracy of the likelihood of occurrence of the particular outcome (e.g., satisfaction of a second threshold determined or configured for the complete set of operands). The first threshold may be set at a higher (or lower) value depending on the desired accuracy. In some embodiments, the processor 124 or comparator may deem the first threshold to be satisfied if the dot-product value for the subset of operands exceeds or is lower than the first threshold by a predetermined or predefined margin, amount, value or distance, In some embodiments, subset of operands is selected so the dot-product value for the subset of operands is expected to exceed or is lower than the first threshold by a predetermined or predefined margin, amount, value or distance,

The AI accelerator 108 may be configured to compare the dot-product value for the subset of operands to the first threshold. In some implementations, the AI accelerator 109 may include a comparator. The comparator may be any device, component, or element that is configured to compare two values. The PE circuit(s) 202 may provide the dot-product value, as an input, to the comparator. The comparator may be configured to generate an output based on the comparison (e.g., a high where the dot-product value satisfies the first threshold). The comparator may be configured to compare the dot-product value for the subset of operands to the first threshold. Based on the result of the comparison (e.g., whether or not the dot-product value satisfies the first threshold), the PE circuit(s) 202 may selectively perform a full dot-product operation on the full set of operands. Where the dot-product value for the subset of operands satisfies the first threshold (or satisfies the first threshold by a particular or sufficient margin, amount, value or distance), the PE circuit(s) 202 may forego computation of the dot-product value for the full set of operands. However, in some embodiments, where the dot-product value for the subset of operands does not satisfy the first threshold (or satisfies the first threshold by a particular or sufficient margin, amount, value or distance), the PE circuit(s) 202 may compute the dot-product value for the full set of operands (e.g., for comparison against a second threshold). In this regard, the PE circuit(s) 202 may be configured to determine whether to compute the dot-product value for the full set of operands based on the result of the comparison.

In some implementations, the PE circuit(s) 202 may be configured to provide the computed value (e.g., dot-product value) for the subset of operands and/or the measured slope of computed values, to the comparator. The comparator may for instance be configured to compare the slope (e.g., rate of increase or decrease) to a slope threshold. For instance, if the slope shows the computed values trending negative (or trending positive), the slope may be an indicator of a likelihood of the full dot-product (e.g., for the full set of operands) satisfying the second threshold. The comparator may maintain one or more thresholds for comparison against the measured slope values. The comparator may be configured to compare the measured slope values (e.g., for various subsets of operands, etc.) to the thresholds maintained by the comparator.

The comparator may be configured to output an activate signal based on the comparison (e.g., of the dot-product value to the minor threshold). In some implementations, the output from the comparator may be a default signal or value when the threshold is satisfied and, where the threshold is not satisfied, the comparator may output a signal value different from the default value. Hence, the comparator may activate to different values (e.g., activate signals) based on the comparison. The activate signal may be a high value (e.g., “1”, a fraction, a decimal value, etc.) in some situations. The activate signal may be a low value (e.g., “0”, a different fraction, a different decimal value, etc.) in certain situations. In some embodiments, responsive to the activate signal, the PE circuit(s) 202 may perform a dot-product operation on the full set of operands. The PE circuit(s) 202 may perform computation of the dot-product operation on the full set of operands (e.g., in accordance with equation 1 or equation 2) responsive to identifying the activate signal. In some implementations, the PE circuit(s) 202 may be configured to output the dot-product value for the full set of operands. The PE circuit(s) 202 may write the dot-product value to the storage device 204, or transmit, send, or otherwise provide the dot-product value to an external device, and so forth. In some implementations, the PE circuit(s) 202 may be configured to provide the dot-product value to a comparator (which may be the same comparator or a different comparator used with the first threshold), which in turn performs a comparison of the dot-product value to the second threshold.

In some embodiments, the PE circuit(s) 202 may generate additional information to indicate whether additional processing of operands (e.g., additional dot-product operation on operands) may be necessary or if an early-exit can occur. One or more bits in the output buffer can be allocated or used to hold or convey such information. For example, PE circuit(s) 202 may perform multiple passes of accumulation for a given convolution. Using the embodiment shown in FIG. 2A as an example, each column of PE circuits 202 can work on a different output kernel. Each column may have their own condition bit (which may be defined based on the activate signal from the respective comparator), which can define or indicate whether further dot-product operation is necessary or is to be performed. Some columns may proceed to early-exit (e.g., after computing a partial dot-product), while some other columns may not proceed to early-exit (e.g., may proceed to perform an additional dot-product operation), which can depend on the operands used. The condition bit(s) for the column(s) in the output buffer can thus be used to indicate whether or not an early-exit is performed. Each of these condition bit can be used to control or gate a respective column on performing early-exit or additional dot-product operation(s).

According to the embodiments described herein, the PE circuit(s) 202 may be configured to selectively perform computation of the dot-product operation on the full set of operands based on a comparison of a dot-product value for a subset of the full set of operands to a first threshold. Thus, the AI accelerator 108 may be configured to conserve computational energy by limiting the instances in which the PE circuit(s) 202 may compute the dot-product operation for the full set of operands. Further, the speed, throughput and/or performance of the AI accelerator 108 may be improved or enhance by limiting the amount of operands on which to perform computation.

Referring now to FIG. 2B, depicted is a flow diagram for a method 210 for early-exit from convolution (or convolution operation or process). The functionalities of method 210 may be implemented using, or performed by, the components described in FIGS. 1A-2A, such as the AI Accelerator 108 and/or device 200. In brief overview, the processors 124 may identify a subset of operands (215). A PE circuit may perform computation of a dot-product operation using the subset of operands (220). The PE circuit may compare a dot-product value to a threshold value (225). The PE circuit may determine whether to activate a node based on the comparison (230).

In further detail of (215), and in some embodiments, the method 210 includes identifying a subset of operands. In some implementations, one or more PE circuit(s) 202 may identify a subset of a set of operands for which to perform a computation of a dot-product operation. The set of operands may be or include input data. The input data may be data received from (computation(s) or activation(s) at) a layer of a neural network (e.g., activation data from node(s) upstream from the PE circuit(s) 202). The operands may include weight(s) (or kernels, bias information, or other information) of the node corresponding to the PE circuit(s) 202 which are to be multiplied or otherwise applied to the input data. The kernel(s) may include a plurality of weights or elements which are to be applied to corresponding input data.

In some implementations, the PE circuit(s) 202 may select a number of operands to include in the subset of operands. The PE circuit(s) 202 may select the number of operands based on a threshold value (e.g., a first threshold value). For instance, the PE circuit(s) 202 may select the number of operands which causes a partial dot-product value computed on the subset of operands to be (at least) an amount lower than (or higher than) the first threshold value to which the partial dot-product value is compared. As described in greater detail below, the PE circuit(s) 202 may perform computation of a dot-product value using the subset of operands (selected at step (215)). The PE circuit(s) 202 may select the number of operands which, at minimum, results in a partial dot product value that is less than (or greater than) the first threshold value. As such, the number of operands may be an amount which, when the PE circuit(s) 202 compute the partial dot-product value, may or may not satisfy the first threshold value to be indicative of an outcome.

Responsive to identifying, determining, or otherwise selecting the number of operands for which to include in the subset of operands, the PE circuit(s) 202 may select the operands from the set of operands for which to include in the subset. The PE circuit(s) 202 may select the operands responsive to the processor(s) 124 re-arranging the set of operands (e.g., ranking the set of operands for selection). The processor(s) 124 may re-arrange the set of operands by sorting the operands (e.g., in ascending or descending order of values of the operands, or in accordance with types of values of the operands). The processor(s) 124 may sort the operands by the corresponding weight (or kernel value), sort the operands by input value (e.g., activation data from the previous node(s) of the neural network), and so forth. The processor(s) 124 may re-arrange the operands by modifying the pointer(s) (in or mapped to a neural network graph) indicating location(s) of the operands (e.g., addresses for the respective operands in memory or other storage device 204). The processor(s) 124 may re-arrange the operands by changing the addresses for the respective operands in memory (where the addresses are indicated in, or mapped to the neural network graph of the neural network). In some implementations, the processor(s) 124 may re-arrange at least some of the operands (e.g., re-arrange or rank the operands according to highest or lowest values, while maintaining or ignoring the operands which do not have the highest or lowest values). In this regard, the processor(s) 124 may re-arrange operands for at least some of the nodes or layers of the neural network graph of the neural network (e.g., while maintaining the operands for other nodes or layers of the neural network graph).

Following re-arranging (e.g., ranking) of the operands, the PE circuit(s) 202 may select operands for including in the subset of operands. The PE circuit(s) 202 may select the operands based on the manner in which the first threshold value is satisfied. For instance, where the first threshold value is satisfied when the dot-product value exceeds the first threshold value, the PE circuit(s) 202 may select the operands having the greatest values to include in the subset of operands. Similarly, where the first threshold value is satisfied when the dot-product value is less than the first threshold value, the PE circuit(s) 202 may select the operands having the least values to include in the subset of operands. The PE circuit(s) 202 may select the operands having the greatest value (or least value) for including in the subset, as computation of a dot-product operation on such operands is more likely to indicate that a dot-product operation on all operands would satisfy a second threshold value (e.g., that is used for configuring, calibrating or determining the first threshold value).

In some implementations, the processor(s) 124 may set the first threshold value. The first threshold may be set such that the likelihood of the dot-product value for all operands (satisfying the second threshold is above a certain level or accuracy (e.g., 80%). For instance, where the second threshold is satisfied when the dot-product value for the full set of operands is above the second threshold, the first threshold may be set sufficiently high that it is unlikely that all operands from the set of operands would result in a dot product value that falls below the second threshold. Similarly, where the second threshold is satisfied when the dot-product value for the full set of operands is below the second threshold, the first threshold may be set sufficiently low that it is unlikely that all operands from the set of operands would rise above the second threshold. The processor(s) 124 may set the threshold value (e.g., the first threshold value) based on a desired accuracy of the neural network's output. In some embodiments, the processor(s) 124 may set the first threshold value closer to the second threshold value and/or increase the subset of selected operands, to increase the desired accuracy of the neural network's output. As a result, the amount of computation and power consumption can increase accordingly. Similarly, the processor(s) 124 may set the first threshold value further away from the second threshold value and/or decrease the subset of selected operands, to decrease the desired accuracy of the neural network's output. As a result, the amount of computation and power consumption can decrease accordingly. Hence, the PE circuit(s) 202 may set the first threshold based on a balance between the level of power savings and the desired accuracy.

In further detail of (220), and in some embodiments, the method 210 includes performing computation of a dot-product operation using the subset of operands. In some implementations, at least one PE circuit 202 for a node of a neural network corresponding to a dot-product operation may perform computation of the dot-product value using the subset of operands (e.g., identified at step (215)). The PE circuit(s) 202 may perform the dot-product operation in accordance with equation 1 or equation 2 described above. The PE circuit(s) 202 may perform the dot-product operation using the input values and corresponding kernel or weight values from the subset of operands. The PE circuit(s) 202 may compute the dot-product value using the operands from the subset.

In further detail of (225), and in some embodiments, the method 210 includes comparing the dot product value to a (first) threshold value. In some implementations, the PE circuit(s) may compare the dot-product value of the subset of the set of operands (e.g., identified at step (220)) to the first threshold value selected by the PE circuit(s) 202 or processor(s) 124. The PE circuit(s) 202 may provide the dot-product value to the comparator. The comparator may use the dot-product value and the first threshold value for the comparison. The comparator may output an activate signal based on the comparison. The comparator may output the activate signal when the dot-product value does not satisfy the first threshold value, or when the dot-product value satisfies the first threshold value. The comparator may output a first value for the activate signal (e.g., when the dot-product value satisfies the first threshold value). The comparator may output a different value for the activate signal where the dot-product value does not satisfy the first threshold value. The activate signal can be a high signal or value (e.g., “1”, a decimal, a fraction, etc.). The default signal can be a low signal or value (e.g., “0”, a different decimal, a different fraction, etc.).

In further detail of (230), and in some embodiments, the method 215 includes determining whether to activate a node based on the comparison. In some implementations, the processor(s) 124 determines whether to activate the PE(s) to perform a dot-product operation on the whole set of operands based at least on a result of the comparison. The PE circuit(s) 202 may activate the PEs in accordance with a value of the activate signal (e.g., from the comparator). Responsive to the value of the activation signal, the PE circuit(s) 202 may perform computation on the full set of operands. The PE circuit(s) 202 may perform computation of a dot-product operation on the full set of operands to generate a different dot-product value. In some implementations, the PE circuit(s) 202 may store the dot-product value in memory (e.g., by performing a write operation to an address of the memory), output the dot-product value to a different component of the AI accelerator 108 (e.g., to a different comparator, to the same comparator, etc.), output the dot-product value to an external device, and so forth. In some implementations, the PE circuit(s) 202 may compare the dot-product value to a second threshold value. In this regard, the PE circuit(s) 202 may in some embodiments selectively perform computation of a dot-product operation on a full set of operands based on a partial dot-product operation using a subset of operands.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method comprising:
performing, by at least one processing element (PE) circuit for a node of a neural network corresponding to a dot-product operation with a set of operands, computation using a subset of the set of operands to generate a dot-product value of the subset of the set of operands;
comparing, by the at least one PE circuit, the dot-product value of the subset of the set of operands, to a threshold value; and
determining, by the at least one PE circuit, whether to activate the node of the neural network, based at least on a result of the comparing.

2. The method of claim 1, further comprising identifying, by the at least one PE circuit, the subset of the set of operands to perform the computation.

3. The method of claim 1, further comprising selecting a number of operands that causes the partial dot-product value to be at least an amount lower than the threshold value, to be the subset of the set of operands.

4. The method of claim 1, further comprising selecting a number of operands that causes the partial dot-product value to be at least an amount higher than the threshold value, to be the subset of the set of operands.

5. The method of claim 1, further comprising re-arranging the set of operands to perform the computation.

6. The method of claim 5, further comprising re-arranging the set of operands by re-arranging a neural network graph of the neural network.

7. The method of claim 1, further comprising re-arranging operands of at least some nodes or layers of a neural network graph of the neural network.

8. The method of claim 1, further comprising setting the threshold value based at least on a desired accuracy of the neural network's output.

9. The method of claim 7, further comprising setting the threshold value based at least on a level of power saving achievable by performing the computation using the subset of the set of operands, instead of using all of the set of operands.

10. The method of claim 1, wherein the set of operands comprise weights or kernels of the node.

11. A device comprising:
at least one processing element (PE) circuit configured to:
perform, for a node of a neural network corresponding to a dot-product operation with a set of operands, computation using a subset of the set of operands to generate a dot-product value of the subset of the set of operands;
compare the dot-product value of the subset of the set of operands, to a threshold value; and
determine whether to activate the node of the neural network, based at least on a result of the comparing.

12. The device of claim 11, wherein the at least one PE circuit is further configured to identify the subset of the set of operands to perform the computation.

13. The device of claim 11, wherein the at least one PE circuit is further configured to select a number of operands that causes the partial dot-product value to be at least an amount lower than the threshold value, to be the subset of the set of operands.

14. The device of claim 11, wherein the at least one PE circuit is further configured to select a number of operands that causes the partial dot-product value to be at least an amount higher than the threshold value, to be the subset of the set of operands.

15. The device of claim 11, further comprising a processor configured to re-arrange the set of operands to perform the computation.

16. The device of claim 15, wherein the processor is configured to re-arrange the set of operands by re-arranging a neural network graph of the neural network.

17. The device of claim 11, further comprising a processor configured to re-arrange operands of at least some nodes or layers of a neural network graph of the neural network.

18. The device of claim 11, further comprising a processor configured to set the threshold value based at least on a desired accuracy of the neural network's output.

19. The device of claim 17, wherein the processor is configured to set the threshold value based at least on a level of power saving achievable by performing the computation using the subset of the set of operands, instead of using all of the set of operands.

20. The device of claim 11, wherein the set of operands comprise weights or kernels of the node.
